(19) United States
(12) Patent Application Publication
(10) Pub. No.: US 2014/0098003 A1
(43) Pub. Date: Apr. 10, 2014

(54) METHOD AND APPARATUS OF DATA TRANSFER DYNAMIC ADJUSTMENT IN RESPONSE TO USAGE SCENARIOS, AND ASSOCIATED COMPUTER PROGRAM PRODUCT

(71) Applicant: Chih-Feng Chien, Hsinchu City (TW)

(72) Inventor: Chih-Feng Chien, Hsinchu City (TW)

(21) Appl. No.: 13/747,483

(22) Filed: Jan. 23, 2013

(30) Foreign Application Priority Data
Oct. 5, 2012 (TW) 101136937

(51) Int. Cl. G06F 13/00

(52) U.S. Cl. CPC G06F 13/00
USPC 345/1.1

(57) ABSTRACT

A method and apparatus of data transfer dynamic adjustment in response to usage scenarios and associated computer program product are provided. The method includes: utilizing at least one communication port of a display control device to receive data packets from at least one electronic device, and utilizing at least one output port of the display control device to output display data or derivative information thereof to at least one display device for display, where the display control device is utilized for performing display control for the at least one electronic device, and the data packets carry display data which represents a video output of the at least one electronic device; and dynamically detecting usage scenarios of the at least one electronic device to generate usage scenario information, and dynamically switching data transfer modes between the display control device and the electronic device according to the usage scenario information.

### BACKGROUND OF THE INVENTION

1. Field of the Invention

The present invention relates to display control of an external display device of an electronic device, and more particularly, to a method and apparatus of dynamic data transfer adjustment in response to usage scenarios and associated computer program product.

2. Description of the Prior Art

Portable electronic devices such as multi-function mobile phones, personal digital assistants (PDA), tablet computers, and laptop computers are quite convenient for users. In certain circumstances, the user may have some problems in using a portable electronic device, such as any one of the above-described types of portable electronic devices. For example, in a situation that the user is using the portable electronic device to play multimedia files or video programs, the user may feel that the display size of the portable electronic device's built-in display module is too small. For another example, in a situation that the user is using the portable electronic device to edit or organize a lot of information, the user may feel that the display size of the portable electronic device's built-in display module is too small.

In response to the above problems, the user may expect a large-size display device located in the living room, such as a large-size flat-panel display or a large-size digital television (TV), as the exterior display device of the portable electronic device; however, there may be some other problems. For example, the portable electronic device and the external display device are not equipped with the same display interface available for image data transfer. For another example, when the user uses the external display device, the speed of data transfer between the portable electronic device and the external display device can not meet the needs of the user at any moment. Thus, there is a need for a novel method to perform the display control of the external display device of the electronic device.

### SUMMARY OF THE INVENTION

Thus, one of the objectives of the present invention is to provide a method and apparatus of dynamic data transfer adjustment in response to usage scenarios and associated computer program product, to solve the problem mentioned above.

Another objective of the present invention is to provide a method and apparatus of dynamic data transfer adjustment in response to usage scenarios and associated computer program product, thereby meeting the needs of the user during the period of using the external display device.

The preferred embodiment of the present invention provides a method of dynamic data transfer adjustment in response to usage scenarios is provided, where the method includes: using at least a communication port of a display control device to receive data packets from at least one electronic device, and utilizing at least an output port of the display control device to output at least one of display data and derivative information thereof to at least a display device for display, wherein the display control device is arranged to perform display control for the at least one electronic device, and the data packets carry the display data, and the display data represents video output of the at least one electronic device; and detecting usage scenario of the at least one electronic device dynamically to generate usage scenario information, and switching data transfer modes between the display control device and the at least one electronic device dynamically according to the usage scenario information.

The present invention also provides an apparatus of dynamic data transfer adjustment in response to usage scenarios correspondingly, wherein the apparatus includes at least a portion of a display control device, the display control device is used to perform display control for an electronic device, the device includes at least one communication port, a processing circuit, and at least one output port. The at least one communication port is arranged to receive data packets from at least one electronic device, wherein the data packets carry the display data, and the display data represents video output of the at least one electronic device. The processing circuit is coupled to the at least one communication port, arranged to control the at least one communication port, and to switch data transfer modes between the display control device and the at least one electronic device dynamically, thereby to adjust at least one of the data integrity and the bandwidth of the data transfer between the display control device and the at least one electronic device dynamically in response to the usage scenario, wherein the at least one electronic device detects usage scenario of the at least one electronic device dynamically to generate usage scenario information, thereby for switching data transfer modes dynamically. The at least one output port is coupled to the processing circuit, arranged to output at least one of display data and derivative information thereof to at least a display device for display.

The present invention also provides a computer program product correspondingly, where the computer program product has program instructions to indicate at least one processor of at least one electronic device to perform a method of dynamic data transfer adjustment in response to usage scenarios, the method comprising following steps: controlling the at least one electronic device to transmit data packets to at least a communication port of a display control device, wherein the display control device is arranged to perform display control for the at least one electronic device, and the data packets carry the display data, and the display data represents video output of the at least one electronic device; and detecting usage scenario of the at least one electronic device dynamically to generate usage scenario information, and switching data transfer modes between the display control device and the at least one electronic device dynamically according to the usage scenario information; wherein at least an output port of the display control device is arranged to output at least one of display data and derivative information thereof to at least a display device for display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus of dynamic data transfer adjustment in response to usage scenarios and a related display system according to a first embodiment of the present invention.

FIG. 2 is a diagram illustrating an embodiment of the display control device shown in FIG. 1.

FIG. 3 is a flow diagram illustrating a method of dynamic data transfer adjustment in response to usage scenarios according to an embodiment of the present invention.

FIG. 4 is a diagram illustrating the workflow involved with the method shown in FIG. 3 according to an embodiment of the present invention.

FIG. 5 is a diagram illustrating the workflow involved with the method shown in FIG. 3 according to another embodiment of the present invention.

FIG. 6 is a diagram illustrating a bandwidth detecting operation involved with the method shown in FIG. 3 according to an embodiment of the present invention.

FIG. 7 is a diagram illustrating a packet format involved with the method shown in FIG. 3 according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

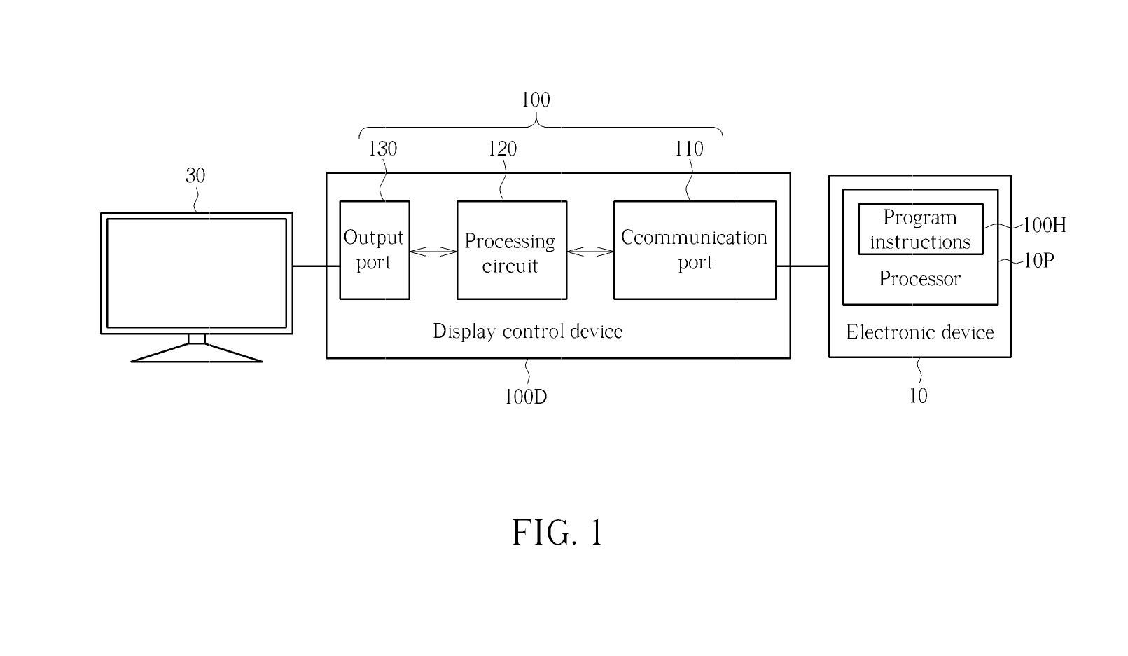

FIG. 1 is a diagram illustrating an apparatus 100 of dynamic data transfer adjustment in response to usage scenarios and a related display system according to a first embodiment of the present invention, wherein the display system includes an electronic device 10, a display control device 100D, and a display device 30. The electronic device 10, for example, may be (but not limited to) a portable electronic device such as a multi-function mobile phone, a personal digital assistant (PDA), a tablet computer, a laptop computer, or a desktop computer. According to this embodiment, the electronic device 10 includes at least a processor 10P, and the processor 10P which executes program instructions 100H may be used to control the apparatus 100 to perform dynamic data transfer adjustment in response to usage scenarios, wherein the computer program product with program instructions 100H may be installed in the electronic device 10 in advance, thus allowing the processor 10P to execute the program instructions 100H. Besides, as shown in FIG. 1, the apparatus 100 includes at least a portion (e.g., part or all) of the display control device 100D, wherein the display control device 100D is used to perform display control of an electronic device such as the electronic device 10. For instance, the apparatus 100 may include the control circuit of the display control device 100D, especially the integrated circuit. For another example, the apparatus 100 may include the entire display control device 100D.

As shown in FIG. 1, the apparatus 100 includes at least one communication port 110 (e.g., one or more than one communication port); a processing circuit 120, coupled to the communication port 110; and at least one output port 130 (e.g., one or more than one output port), coupled to the processing circuit 120. The at least one communication port 110 mentioned above is arranged to receive data packets from at least one electronic device, such as the electronic device 10, wherein the data packets carry the display data, and the display data represents a video output of the at least one electronic device (e.g., the electronic device 10). In addition, the processing circuit 120 is arranged to control the at least one communication port 110 mentioned above, and to switch data transfer modes between the display control device 100D and the above at least one electronic device (e.g., the electronic device 10) dynamically under the control of the above at least one electronic device, such as the electronic device 10 (especially the processor 10P which executes the program instructions 100H), thereby dynamically adjusting at least one of the data integrity and the bandwidth of the data transfer between the display control device 100D and the above at least one electronic device in response to the usage scenario. Specifically, the at least one electronic device detects the usage scenario of the at least one electronic device dynamically to generate usage scenario information referenced for switching data transfer modes dynamically. The at least one output port 130 is arranged to output at least one of the display data and derivative information thereof (i.e., information derived from the display data) to at least a display device, such as the display device 30, for display/playback. For instance, the processing circuit 120 may convert the display data to the derivative information for adjusting the refresh rate, brightness, and/or color of the video output mentioned above, wherein the output port 130 may output the derivative information to the at least one display device, such as the display device 30. For another example, the processing circuit 120 may bypass the display data without generating the derivative information, wherein the output port 130 may output the display data to the at least one display device, such as the display device 30, for display.

In practice, the processing circuit 120 may include a processor, a firmware code, and/or a logic circuit, wherein the firmware code may be stored in a storage unit of the apparatus 100, such as a non-volatile memory, for being retrieved and executed. However, this is for illustrative purpose only, and is not meant to be a limitation for the present invention. According to some embodiments such as the first embodiment and alternative designs thereof, the above mentioned firmware code may be replaced by other type of program code. In addition, examples of the communication port 110, for instance, may include (but not limited to) a USB port, a Wireless Fidelity (Wi-Fi) interface, etc. Besides, examples of the aforementioned output port 130 may include a High-Definition Multimedia Interface (HDMI) output port, a Video Graphics Array (VGA) output port, and a Digital Visual Interface (DVI) output port.

According to an alternative design of this embodiment, the above mentioned at least one electronic device may include a plurality of electronic device, such as some of the above mentioned various types of electronic devices, and the aforementioned communication port 110 may include a plurality of communication ports, wherein the processing circuit 120 may receive data packets from the plurality of electronic devices via the plurality of communication ports. According to another alternative design of this embodiment, the above mentioned at least one electronic device may include a plurality of display devices, and the output port 130 may include a plurality output ports, wherein the processing circuit 120 may output at least one of the display data and the derivative information thereof to the plurality of display devices via the plurality of output ports for display/playback.

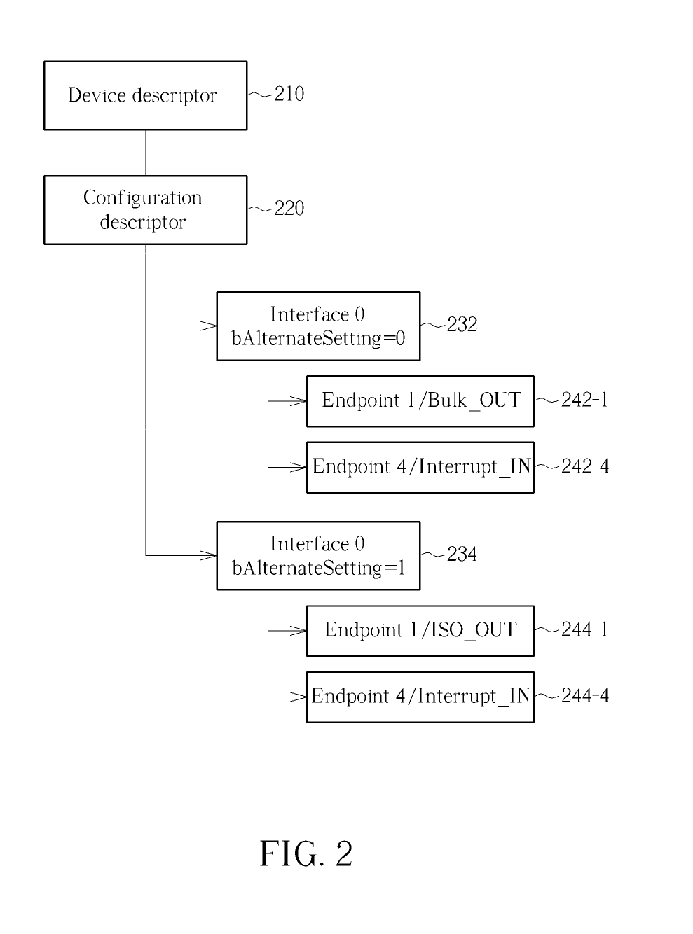

FIG. 2 is a diagram illustrating an embodiment of the display control device 100D (especially the device 100) shown in FIG. 1. According to this embodiment, the communication port 110 may be a USB port, and the display control device 100D may be a USB device. Under the control of the processing circuit 120, the apparatus 100 may provide the USB device information, such as that shown in FIG. 2, to the above mentioned electronic device, such as the electronic device 10. For instance, when a user connects the USB port of the display control device 100D to the electronic device 10, a USB device initialization process may be triggered. During the USB device initialization process, the display control device 100D may provide a device descriptor 210, at least one configuration descriptor 220, a plurality of interface descriptors 232,234, and a plurality of endpoint descriptors 242-1,242-4,244-1, and 244-4 to the electronic device 10 via the USB port in response to the request of the electronic device 10 under the control of the processing circuit 120, thereby allowing the electronic device 10 to control the switching of the data transfer modes by designating a specific parameter, such as the parameter bAlternateSetting. The interface descriptors 232,234 indicate the corresponding information of the interface 0 under one condition where parameter bAlternateSetting=0 and another condition where parameter bAlternateSetting=1, respectively. The endpoint descriptors 242-1,242-4 indicate the corresponding information of endpoint 1 and endpoint 4 of the interface 0 under the condition where parameter bAlternateSetting=0, and the endpoint descriptors 244-1,244-4 indicate the corresponding information of endpoint 1 and endpoint 4 of the interface 0 under the condition where parameter bAlternateSetting=1.

In particular, the electronic device 10 may obtain the data transfer mode of each endpoint from the endpoint descriptors 242-1,242-4,244-1,244-4. For facilitating understanding of technical features of the present invention, symbols Bulk_out, ISO_OUT, and Interrupt_IN are employed in FIG. 2 to represent these data transfer modes. For instance, under the condition where parameter bAlternateSetting 32 0, the data transfer modes of the endpoints 1 and 4 of the interface 0 are respectively labeled as Bulk_out and Interrupt_IN, it means that, for the electronic device 10, endpoint 1 is used to output data to the display control device 100D via BULK mode, and the endpoint 4 is used to input information from the display control device 100D via Interrupt mode, wherein suffixes OUT and IN indicate output and input respectively. For another example, under the condition where parameter bAlternateSetting=1, the data transfer modes of the endpoints 1 and 4 of the interface 0 are respectively labeled as ISO_out and Interrupt_IN, it means that, for the electronic device 10, endpoint 1 is used to output data to the display control device 100D via ISO mode, and the endpoint 4 is used to input information from the display control device 100D via Interrupt mode, wherein suffixes OUT and IN indicate output and input respectively.

Since the apparatus 100 provides the USB device information to the above mentioned at least one electronic device, such as the electronic device 10, the data transfer channel between the electronic device 10 and the display control device 100D can be established in accordance with the USB device information. The processor 10P which executes the program instructions 100H can control the electronic device 10 to transfer data packets to the communication port 110 of the display control device 100D. In addition, The processor 10P which executes the program instructions 100H can detect the usage scenarios of the electronic device 10 to generate usage scenario information referenced to switch the data transfer modes between the display control device 100D and the electronic device 10, such that at least one of the data integrity and bandwidth of the data transfer between the display control device 100D and the electronic device 10 is dynamically adjusted in response to the usage scenario. For instance, the processor 10P which executes the program instructions 100H may designate parameter bAlternateSetting=0 to thereby switch to the BULK mode. For another example, the processor 10P which executes the program instructions 100H may designate parameter bAlternateSetting=1 to thereby switch to the ISO mode.

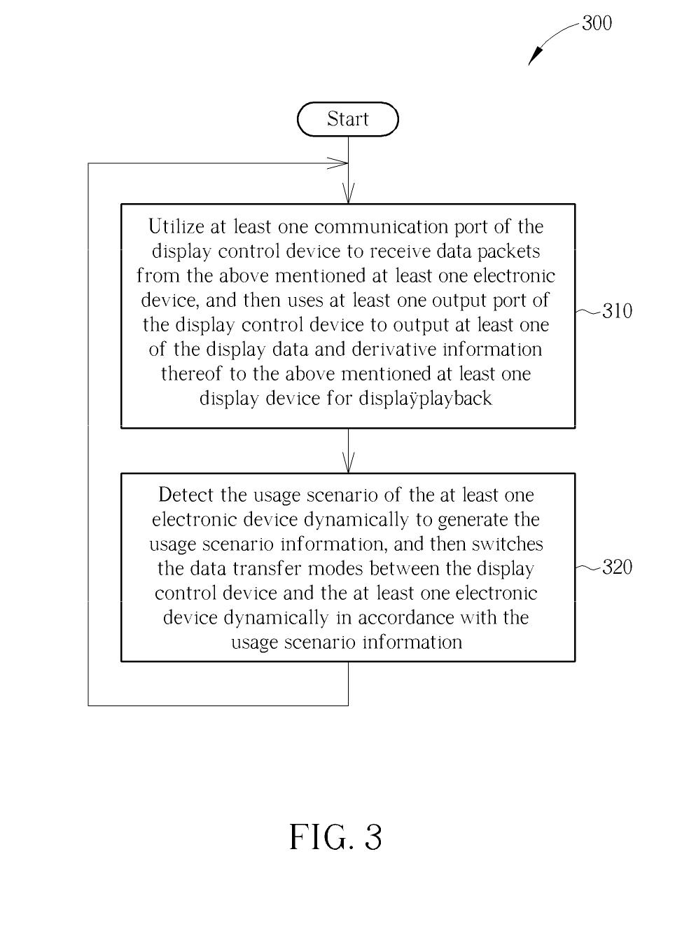

FIG. 3 is a flowchart illustrating a method of dynamic data transfer adjustment in response to usage scenarios according to an embodiment of the present invention. The method may be applied to the apparatus 100 in FIG. 1, especially the processing circuit 120 of the apparatus 100. In addition, the method may be applied to the electronic device 10 in FIG. 1, especially the program instructions 100H of the electronic device 10, wherein the computer program product having the program instructions 100H may be installed in the electronic device 10 in advance, thereby allowing the processor 10P to execute the program instructions 100H to control related operations of the method. The method is described below:

In step 310, the processing circuit 120 utilizes at least one communication port 110 of the display control device 100D to receive data packets from the above mentioned at least one electronic device, such as the electronic device 10, and then uses at least one output port 130 of the display control device 100D to output at least one of the display data and derivative information thereof to the above mentioned at least one display device, such as the display device 30, for display/playback. However, this is for illustrative purpose only, and is not meant to be a limitation to the present invention. For the above mentioned at least one electronic device such as the electronic device 10, the corresponding operation of receiving the data packets as mentioned above may be described as: in step 310, the processor 10P which executes the program instructions 100H controls the above mentioned at least one electronic device, such as the electronic device 10, to transfer the data packets to at least one communication port 110 of the display control device 100D.

In step 320, the above mentioned at least one electronic device such as the electronic device 10 (in particular, the processor 10P which executes the program instructions 100H) detects the usage scenario of the at least one electronic device dynamically to generate the usage scenario information, and then switches the data transfer modes between the display control device 100D and the at least one electronic device dynamically in accordance with the usage scenario information. In particular, the above mentioned at least one electronic device such as the electronic device 10 (especially the processor 10P which executes the program instructions 100H) detects the usage scenario of the at least one electronic device dynamically to generate the usage scenario information, and then adjusts at least one of the data integrity and the bandwidth of the data transfer between the display control device 100D and the at least one electronic device dynamically in accordance with the usage scenario information.

In practice, the operation of the step 320 may be performed by the processor 10P which executes the program instructions 100H, and the display control device 100D can switch data transfer modes by only following the indications of the electronic device 10 passively. For instance, the processor 10P which executes the program instructions 100H may performs the operation of dynamically detecting the usage scenario of the at least one electronic device to generate the usage scenario information by monitoring the amount of data carried by the data packets. Especially, the processor 10P which executes the program instructions 100H may further switch the data transfer modes between the display control device 100D and the at least one electronic device dynamically according to the usage scenario information. Since the data amount (or packet traffic) of video playback performed by the electronic device 10 executing a video playback program is usually greater than the data amount (or packet traffic) of other programs, such as the programs for text editing or document editing, executed by the electronic device 10. Thus, by performing the data amount detection (or packet traffic detection), the processor 10P which executes the program instructions 100H can perform step 320. Therefore, if it is detected that the electronic device 10 is performing video playback by the video playback program, the processor 10P which executes the program instructions 100H can instruct the electronic device 10 to switch to a certain mode, such as the ISO mode, to maintain isochronous data transfer. Otherwise, the processor 10P which executes the program instructions 100H can instruct the electronic device 10 to switch to a different mode, such as the BULK mode, to maintain the data integrity.

According to an alternative design of this embodiment, the processor 10P which executes the program instructions 100H may detect the usage scenario of the at least one electronic device dynamically to generate the usage scenario information via monitoring the variation of the data amount corresponding to at least one screen area (especially more than one screen area). For instance, the screen area may represent a portion of a full screen. For another example, the screen area may represent the entire area of the full screen. According to another alternative design of this embodiment, the processor 10P which executes the program instructions 100H may detect the usage scenario of the at least one electronic device dynamically to generate the usage scenario information via monitoring the size of at least one application window. For instance, when the size of a certain application window is greater than a specific scale (e.g., ½) of the aforementioned full screen area, the processor 10P which executes the program instructions 100H may examine whether an application program to which the application window belongs is a video playback program, such as the above mentioned video playback program. In particular, according to a default setting or user preference setting, when it is detected that the application program to which the application window belongs is a video playback program, the processor 10P which executes the program instructions 100H may determine that the electronic device 10 is performing video playback by the video playback program. Therefore, if it is detected that the electronic device 10 is performing video playback by the video playback program, the processor 10P which executes the program instructions 100H may decide to switch to the ISO mode to maintain isochronous data transfer. Otherwise, the processor 10P which executes the program instructions 100H may decide to switch to the BULK mode to maintain the data integrity.

According to some alternative designs of this embodiment, at least a portion (e.g., part or all) of the operation of the step 310 and at least a portion (e.g., part or all) of the operation of the step 320 may be performed simultaneously. According to some alternative designs of this embodiment, in the loop of FIG. 3, at least a portion (e.g., part or all) of the operation of the step 310 and/or at least a portion (e.g., part or all) of the operation of the step 320 may be performed repeatedly.

According to some alternative designs of this embodiment, the data transfer modes may include a first mode (e.g., the BULK mode) and a second mode (e.g., the ISO mode), and in the step 320, the operation of detecting usage scenario of the at least one electronic device dynamically to generate usage scenario information may include:
detecting whether a user of a specific electronic device (e.g., the electronic device 10) of the at least one electronic device designates the first mode to thereby obtain a first detecting result;
detecting whether a video player (such as the above mentioned video playback program) of the specific electronic device is in an inactive status to thereby obtain a second detecting result, wherein the inactive status represents that the video player is not playing video programs;
detecting whether the compression of the data transfer between the display control device 100D and a specific electronic device of an electronic device is enabled by examining at least one packet header, and accordingly obtaining a third detecting result; and
detecting whether the bandwidth of the data transfer between the display control device 100D and a specific electronic device of an electronic device is enough by examining whether any packet is lost and/or by monitoring the round-trip time of at least a portion of the data packets, and accordingly obtaining a fourth detecting result.

Please note that the naming of these detection results is just used to distinguish the detection results of the different detection operations, and the naming of these detection results does not represent the generation order of these detecting results. In addition, the usage scenario information is generated at least based on the first detecting result, the second detecting result, the third detecting result, and the fourth detecting result. For instance, the processor 10P which executes the program instructions 100H may perform the detecting operations mentioned above to generate the detecting results. Besides, in the step 320, the operations of switching the data transfer modes between the display control device 100D and the at least one electronic device dynamically according to the usage scenario information may include:
for the data transfer between the display control device 100D and the specific electronic device, if the usage scenario information indicates that any one of the first detecting result, the second detecting result, the third detecting result, and the fourth detecting result is true, entering the first mode; otherwise (i.e., the usage scenario information indicates that all of the first detecting result, the second detecting result, the third detecting result, and the fourth detecting result are false), entering the second mode. According to the programmer's point of view, the above true/false can be regarded as the logic values of the detecting operations.

In particular, the processor 10P which executes the program instructions 100H may perform the control of entering the first mode/the second mode mentioned above. For instance, under the condition where the data transfer between the display control device 100D and the specific electronic device corresponds to the first mode, entering the first mode represents maintaining in the first mode, and entering the second mode represents switching to the second mode. For another example, under the condition where the data transfer between the display control device 100D and the specific electronic device corresponds to the second mode, entering the second mode represents maintaining in the second mode, and entering the first mode represents switching to the first mode.

In practice, the first mode and the second mode may be used to represent the BULK mode and the ISO mode respectively, wherein the first mode is used to maintain data integrity, and the second mode is used to maintain isochronous data transfer.

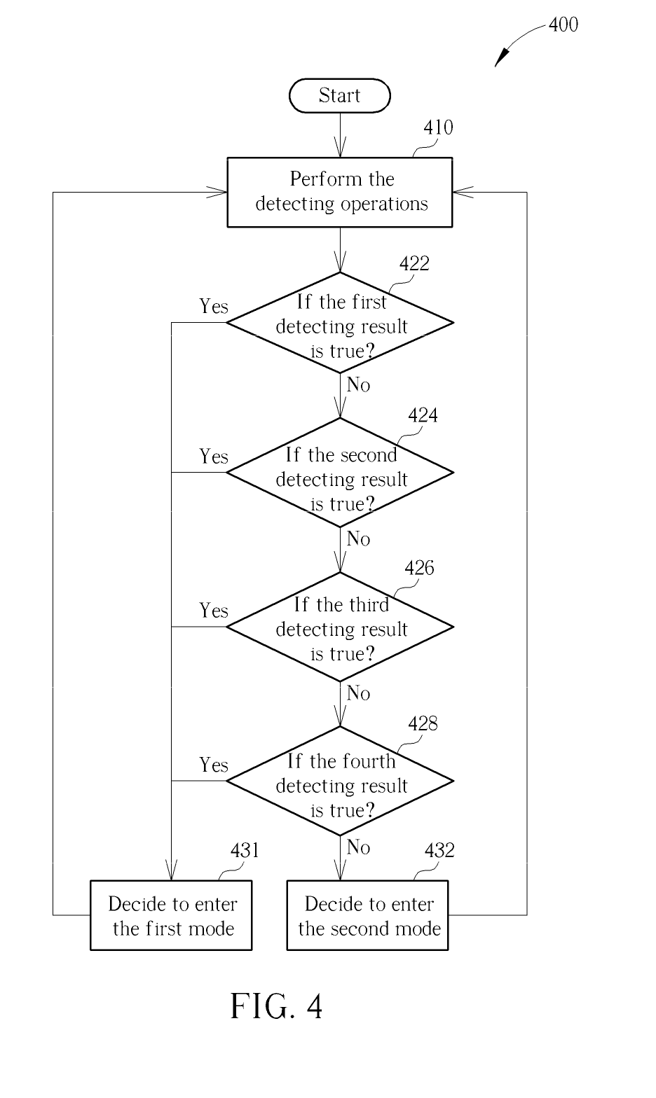

FIG. 4 is a diagram illustrating the workflow 400 involved with the method 300 shown in FIG. 3 according to an embodiment of the present invention.

In the step 410, the processor 10P which executes the program instructions 100H performs the detecting operations mentioned above to generate the first detecting result, the second detecting result, the third detecting result, and the fourth detecting result. For instance, the logic values of the detecting results (i.e., the true/false of the first detecting result, the second detecting result, the third detecting result, and the fourth detecting result, respective) may be stored in at least one register temporarily for further examination.

In the step 422, the processor 10P which performs the program instructions 100H examines the first detecting result generated from step 410. If the first detecting result is true (it means that user specifies the first mode), the flow proceeds with step 431; otherwise, the flow proceeds with step 424.

In the step 424, the processor 10P which executes the program instructions 100H examines the second detecting result generated from step 410. If the second detecting result is true (it means that the video player is in an inactive status), the flow proceed with step 431; otherwise, the flow proceeds with step 426.

In the step 426, the processor 10P which executes the program instructions 100H examines the third detecting result generated from step 410. If the third detecting result is true (it means that the compression is enabled), the flow proceeds with step 431; otherwise, the flow proceeds with step 428.

In the step 428, the processor 10P which executes the program instructions 100H examines the fourth detecting result generated from step 410. If the fourth detecting result is true (it means that the bandwidth is enough), the flow proceeds with step 431; otherwise, the flow proceeds with step 432.

In the step 431, the processor 10P which executes the program instructions 100H decides to enter the first mode. For instance, under the condition where the data transfer between the display control device 100D and the specific electronic device corresponds to the first mode originally before step 431 is performed, entering the first mode represents maintaining in the first mode. For another example, under the condition where the data transfer between the display control device 100D and the specific electronic device corresponds to the second mode originally before step 431 is performed, entering the first mode represents switching to the first mode.

In the step 432, the processor 10P which executes the program instructions 100H decides to enter the second mode. For instance, under the condition where the data transfer between the display control device 100D and the specific electronic device corresponds to the second mode originally before step 432 is performed, entering the second mode represents maintaining in the second mode. For another example, under the condition where the data transfer between the display control device 100D and the specific electronic device corresponds to the first mode originally before the step 432 is performed, entering the second mode represents switching to the second mode.

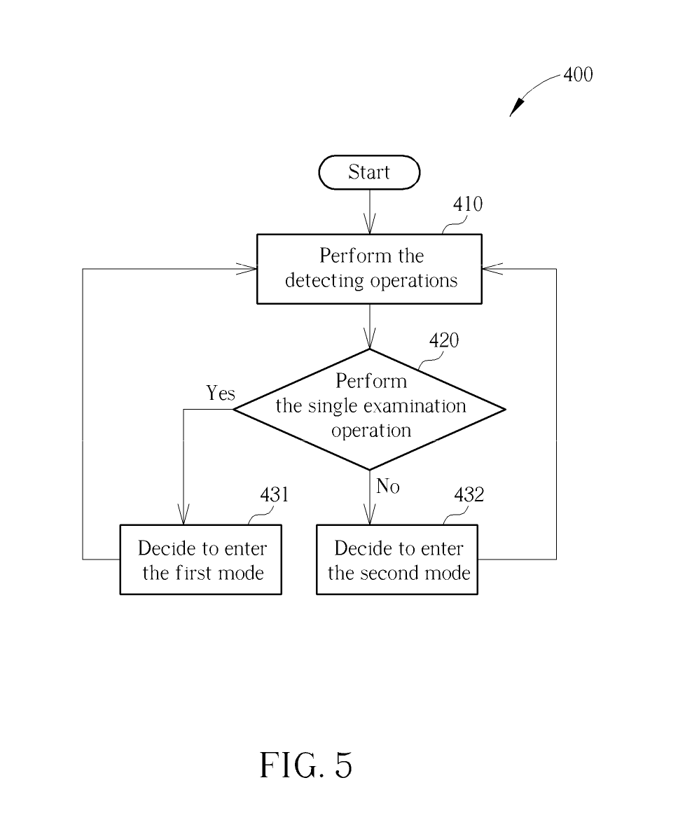

Please note that the usage scenario information may include the first detecting result, the second detecting result, the third detecting result, and the fourth detecting result. In addition, for facilitating understanding of technical features of the present invention, examination operations of steps 422-428 are illustrated in FIG. 4 to be performed in order; however, this is for illustrative purpose only, and is not meant to be a limitation of the present invention. According to an alternative design of this embodiment, such as the embodiment shown in FIG. 5, examination operations of steps 422-428 may be integrated into a single examination operation as follows:

In the step 420, the processor 10P which executes the program instructions 100H performs the single examination operation upon the first detecting result, the second detecting result, the third detecting result, and the fourth detecting result, especially a logical “OR” operation upon the first detecting result, the second detecting result, the third detecting result, and the fourth detecting result, wherein the computation result of the logical “OR” operation may be regarded as the computation result of the single examination operation, which may also be regarded as an example of the usage scenario information. When the computation result of the single examination operation is true (it means that user specifies the first mode, or the video player is in the inactive status, or the compression is enabled, or the bandwidth is enough), the flow proceeds with step 431; otherwise, the flow proceeds with step 432.

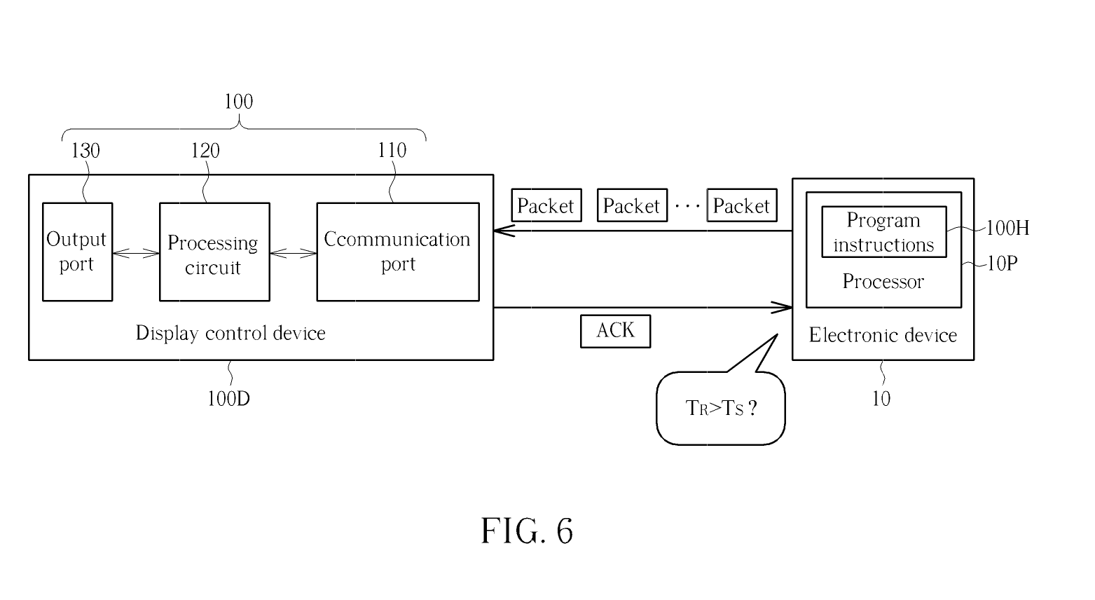

FIG. 6 is a diagram illustrating a bandwidth detecting operation with the method 300 shown in FIG. 3 according to an embodiment of the present invention. Under the control of the processor 10P which executes the program instructions 100H, the electronic device 10 transfers the aforementioned data packets to the display control device 100D. In addition, under the control of the processing circuit 120, the display control device 100D may transfer an acknowledgment packet (labeled as “ACK” in FIG. 6, wherein the acknowledgment packet carries confirmation/acknowledgement information) to confirm receipt of a data packet. Consequently, the processor 10P which executes the program instructions 100H may calculate a time difference between the time of the data packet transmitted and the time of the acknowledgement packet received, wherein the time difference may be regarded as the above mentioned round-trip time, and can be expressed by the symbol T_{R}. In practice, if the electronic device 10 does not receive the acknowledgement packet, it means that the data packet is lost, and the electronic device 10 usually needs to re-transmit the data packet.

According to the present embodiment, the processor 10P which executes the program instructions 100H may perform statistical analysis of the round-trip time T_{R} for at least a portion of the data packets, thereby determining a safe time parameter T_{S}, wherein the safe time parameter T_{S} represents the time period that packets can be transmitted smoothly without any packet loss. As shown in FIG. 6, the processor 10P which executes the program instructions 100H can perform the above mentioned bandwidth detection operation by monitoring the round-trip time T_{R}. In particular, the processor 10P which executes the program instructions 100H can determine whether the bandwidth is enough by detecting whether the round-trip time T_{R} is greater than the safe time parameter T_{S} (labeled as “T_{R}>T_{S}” in FIG. 6). For instance, when the round-trip time T_{R} is greater than the safe time parameter T_{S}, the processor 10P which executes the program instructions 100H would determine that the bandwidth is not enough; otherwise, the processor 10P which executes the program instructions 100H would determine that the bandwidth is enough. Therefore, the processor 10P which executes the program instructions 100H would generate the aforementioned four detecting results by monitoring the round-trip time T_{R} of at least a portion of the data packets (e.g., the examination operation labeled as “T_{R}>T_{S}?” in FIG. 6).

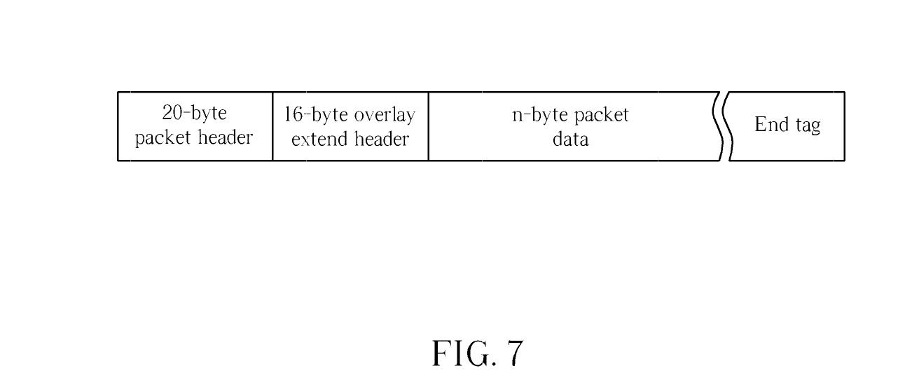

FIG. 7 is a diagram illustrating a packet format involved with the method 300 shown in FIG. 3 according to an embodiment of the present invention. According to the packet format, the beginning of a data packet has a 20-byte packet header. Furthermore, the data packet may further include a 16-byte overlay extend header, and an n-byte packet data, where n is a positive integer. In addition, according to the packet format, the data packet considered is ended with an end tag. Based on the packet format, the transmission end (e.g., the electronic device 10) and the receiving end (e.g., the display control device 100D) may perform data transfer and related controls.

According to this embodiment, the first few fields of the packet header shown in FIG. 7 sequentially include a packet tag, a header length, a packet index, and an encode type, wherein the lengths thereof can be 8-bit, 8-bit, 12-bit, and 4-bit, respectively. The information in the field of the packet tag may be a fixed value, 0xFB (in hexadecimal notation), and the information in the field of the header length may indicate that the header length of the packet header is 20 bytes. Besides, the information in the field of the packet index may be designated as an integer in the range of the interval [0, 4095], and the information in the field of the packet index may be specified by the transmission end (e.g., the electronic device 10) for each data packet, and thus the receiver end (e.g., the display control device 100D) may identify the order of the data packets, and may perform the above mentioned confirmation operation one by one. In addition, the information in the field of the above mentioned encode type is used to indicate the encode type of the display data carried by the field of the packet data, wherein the information in the field of the encode type may be designated as an integer in the range of the interval [0, 15], and the information in the field of the packet index may be specified by the transmission end (e.g., the electronic device 10) for each data packet.

For instance, under the condition where the information in the field of the encode type is designated as 0, 1, and 2, the encode type of the packet data is encode type DISPLAY_ENCODE_RGB24_RAW, encode type DISPLAY_ENCODE_RGB24_COMPRESS, and encode type DISPLAY_ENCODE_RGB32_RAW, respectively. The symbol “RGB” in the encode types represents that the encoding channels contain a red channel R, a green channel G, and a blue channel B respectively; and symbols “24” and “32” in the encode types represent the number of encode bits respectively. In practice, either of the encode type DISPLAY_ENCODE_RGB24_RAW and encode type DISPLAY_ENCODE_RGB24_COMPRESS corresponds to the encode channels R, G, and B, and encode type DISPLAY_ENCODE_RGB32_RAW corresponds to the encode channels R, G, B, and A, wherein the encode channel A may represent a blending channel. Moreover, the symbol “RAW” and the symbol “COMPRESS” represent the original data (i.e., the compression is not enabled) and the compressed data (i.e., the compression is enabled) respectively. Thus, the processor 10P which executes the program instructions 100H can generate the third detecting result mentioned above according to the packet format shown in FIG. 7.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of dynamic data transfer adjustment in response to usage scenarios, comprising:
using at least a communication port of a display control device to receive data packets from at least one electronic device, and utilizing at least an output port of the display control device to output at least one of display data and derivative information thereof to at least a display device for display wherein the display control device is arranged to perform display control for the at least one electronic device, and the data packets carry the display data, and the display data represents a video output of the at least one electronic device; and
detecting a usage scenario of the at least one electronic device dynamically to generate usage scenario information, and switching data transfer modes between the display control device and the at least one electronic device dynamically according to the usage scenario information.

2. The method of claim 1, wherein the step of switching the data transfer modes between the display control device and the at least one electronic device dynamically according to the usage scenario information further comprises:
switching the data transfer modes between the display control device and the at least one electronic device dynamically according to the usage scenario information, for dynamically adjusting at least one of a data integrity and a bandwidth of a data transfer between the display control device and the at least one electronic device in response to the usage scenario.

3. The method of claim 1, wherein the step of detecting the usage scenario of the at least one electronic device dynamically to generate the usage scenario information further comprises:
detecting whether a video player of a specific electronic device of the at least one electronic device is in an inactive status to thereby obtain a detecting result, wherein the inactive status represents that the video player is not playing a video program;
wherein the usage scenario information is generated according to at least the detecting result.

4. The method of claim 1, wherein the step of detecting the usage scenario of the at least one electronic device dynamically to generate the usage scenario information further comprises:
detecting whether compression of a data transfer between the display control device and a specific electronic device of the at least one electronic device is enabled via examining at least a packet header, and accordingly obtaining a detecting result;
wherein the usage scenario information is generated according to at least the detecting result.

5. The method of claim 1, wherein the step of detecting the usage scenario of the at least one electronic device dynamically to generate the usage scenario information further comprises:
detecting whether a bandwidth of a data transfer between the display control device and a specific electronic device of the at least one electronic device is enough via examining whether any packet losses and/or monitoring a round-trip time of at least a portion of the data packets, and accordingly obtaining a detecting result;
wherein the usage scenario information is generated according to at least the detecting result.

6. The method of claim 1, wherein the data transfer modes comprise a first mode and a second mode, and the first mode is different from the second mode; and
the step of detecting the usage scenario of the at least one electronic device dynamically to generate the usage scenario information further comprises:
detecting whether a user of a specific electronic device of the at least one electronic device designates the first mode to thereby obtain a first detecting result;
detecting whether a video player of the specific electronic device is in an inactive status to thereby obtain a second detecting result;
detecting whether a compression of a data transfer between the display control device and the specific electronic device is enabled, and accordingly obtaining a third detecting result; and
detecting whether a bandwidth of the data transfer between the display control device and the specific electronic device is enough, and accordingly obtaining a fourth detecting result;
wherein the usage scenario information is generated according to at least the first detecting result, the second detecting result, the third detecting result, and the fourth detecting result.

7. The method of claim 6, wherein the step of switching the data transfer modes between the display control device and the at least one electronic device dynamically according to the usage scenario information further comprises:
for the data transfer between the display control device and the specific electronic device, if the usage scenario information indicates that any one of the first detecting result, the second detecting result, the third detecting result, and the fourth detecting result is true, entering the first mode; otherwise, entering the second mode;
wherein the first mode is used to maintain data integrity, and the second mode is used to maintain isochronous data transfer.

8. The method of claim 1, wherein the step of detecting the usage scenario of the at least one electronic device dynamically to generate the usage scenario information further comprises:
monitoring variation of a data amount corresponding to at least one screen area to detect the usage scenario of the at least one electronic device dynamically, and accordingly generating the usage scenario information.

9. The method of claim 1, wherein the step of detecting the usage scenario of the at least one electronic device dynamically to generate the usage scenario information further comprises:
monitoring a size of at least one application window to detect the usage scenario of the at least one electronic device dynamically, and accordingly generating the usage scenario information.

10. An apparatus of dynamic data transfer adjustment in response to usage scenarios, the apparatus comprising at least a portion of a display control device, the display control device being used to perform display control for an electronic device, the apparatus comprising:
at least one communication port, arranged to receive data packets from at least one electronic device, wherein the data packets carry display data, and the display data represents a video output of the at least one electronic device;
a processing circuit, coupled to the at least one communication port, arranged to control the at least one communication port, and to switch data transfer modes between the display control device and the at least one electronic device dynamically for dynamically adjusting at least one of a data integrity and a bandwidth of a data transfer between the display control device and the at least one electronic device in response to a usage scenario, wherein the at least one electronic device detects the usage scenario of the at least one electronic device dynamically to generate a usage scenario information referenced for switching the data transfer modes dynamically; and
at least one output port, coupled to the processing circuit, arranged to output at least one of the display data and derivative information thereof to at least a display device for display.

11. The apparatus of claim 10, wherein in response to a request of the at least one electronic device, the display control device provides a device descriptor, at least one configuration descriptor, a plurality of interface descriptors, and a plurality of endpoint descriptors to the at least one electronic device via the at least one communication port under control of the processing circuit, thus allowing the at least one electronic device to control switching of the data transfer modes by designating a specific parameter; and the interface descriptors indicate corresponding information of an interface under a first condition where the specific parameter equals to a first value and a second condition where the specific parameter equals to a second value, respectively; and a first endpoint descriptor of the plurality of endpoint descriptors indicates corresponding information of a first endpoint and a second endpoint of the interface under the first condition where the specific parameter equals to the first value, and a second endpoint descriptor of the plurality of endpoint descriptors indicates corresponding information of the first endpoint and the second endpoint of the interface under the second condition where the specific parameter equals to the second value.

12. A computer program product, having program instructions to instruct at least one processor of at least one electronic device to perform a method of dynamic data transfer adjustment in response to usage scenarios, the method comprising following steps:
controlling the at least one electronic device to transmit data packets to at least a communication port of a display control device, wherein the display control device is arranged to perform display control for the at least one electronic device, the data packets carry display data, and the display data represents a video output of the at least one electronic device; and
detecting a usage scenario of the at least one electronic device dynamically to generate usage scenario information, and switching data transfer modes between the display control device and the at least one electronic device dynamically according to the usage scenario information;
wherein at least an output port of the display control device is arranged to output at least one of the display data and derivative information thereof to at least a display device for display.

13. The computer program product of claim 12, wherein the step of switching the data transfer modes between the display control device and the at least one electronic device dynamically according to the usage scenario information further comprises:
switching the data transfer modes between the display control device and the at least one electronic device dynamically according to the usage scenario information for dynamically adjusting at least one of a data integrity and a bandwidth of a data transfer between the display control device and the at least one electronic device in response to the usage scenario.

14. The computer program product of claim 12, wherein the step of detecting the usage scenario of the at least one electronic device dynamically to generate the usage scenario information further comprises:
detecting whether a video player of a specific electronic device of the at least one electronic device is in an inactive status to thereby obtain a detecting result, wherein the inactive status represents that the video player is not playing a video program;
wherein the usage scenario information is generated according to at least the detecting result.

15. The computer program product of claim 12, wherein the step of detecting the usage scenario of the at least one electronic device dynamically to generate the usage scenario information further comprises:
detecting whether a compression of a data transfer between the display control device and a specific electronic device of the at least one electronic device is enabled via examining at least a packet header, and accordingly obtaining a detecting result;
wherein the usage scenario information is generated according to at least the detecting result.

16. The computer program product of claim 12, wherein the step of detecting the usage scenario of the at least one electronic device dynamically to generate the usage scenario information further comprises:
detecting whether a bandwidth of a data transfer between the display control device and a specific electronic device of the at least one electronic device is enough via examining whether any packet losses and/or monitoring a round-trip time of at least a portion of the data packets, and accordingly obtaining a detection result;
wherein the usage scenario information is generated according to at least the detecting result.

17. The computer program product of claim 12, wherein the data transfer modes comprises a first mode and a second mode, and the first mode is different from the second mode; and the step of detecting the usage scenario of the at least one electronic device dynamically to generate the usage scenario information further comprises:
detecting whether a user of a specific electronic device of the at least one electronic device designates the first mode to thereby obtain a first detecting result;
detecting whether a video player of the specific electronic device is in an inactive status to thereby obtain a second detecting result;
detecting whether a compression of a data transfer between the display control device and the specific electronic device is enabled, and accordingly obtaining a third detecting result; and
detecting whether a bandwidth of the data transfer between the display control device and the specific electronic device is enough, and accordingly obtaining a fourth detecting result;
wherein the usage scenario information is generated according to at least the first detecting result, the second detecting result, the third detecting result, and the fourth detecting result.

18. The computer program product of claim 17, wherein the step of switching the data transfer modes between the display control device and the at least one electronic device dynamically according to the usage scenario information further comprises:
for the data transfer between the display control device and the specific electronic device, if the usage scenario information indicates that any one of the first detecting result, the second detecting result, the third detecting result, and the fourth detecting result is true, entering the first mode; otherwise, entering the second mode;
wherein the first mode is used to maintain data integrity, and the second mode is used to maintain isochronous data transfer.

19. The computer program product of claim 12, wherein the step of detecting the usage scenario of the at least one electronic device dynamically to generate the usage scenario information further comprises:
monitoring variation of a data amount corresponding at least one screen area to detect the usage scenario of the at least one electronic device dynamically, and accordingly generating the usage scenario information.

20. The computer program product of claim 12, wherein the step of detecting the usage scenario of the at least one electronic device dynamically to generate the usage scenario information further comprises:
monitoring a size of at least one application window to detect the usage scenario of the at least one electronic device dynamically, and accordingly generating the usage scenario information.
